(19) United States
(12) Patent Application Publication
(10) Pub. No.: US 2023/0394523 A1
(43) Pub. Date: Dec. 7, 2023

(54) SYSTEMS AND METHODS FOR PRESENTING BRANDING OPPORTUNITIES

(71) Applicant: Event Brand LLC, Unionville, CT (US)

(72) Inventors: Kerry Doherty Laberge, Unionville, CT (US); Adam D. Laberge, Unionville, CT (US); William Miller, East Hampton, CT (US)

(21) Appl. No.: 18/329,939

(22) Filed: Jun. 6, 2023

Related U.S. Application Data
(60) Provisional application No. 63/349,312, filed on Jun. 6, 2022.

(51) Int. Cl. G06Q 30/0242; G06Q 30/0241; G06Q 30/0251

(52) U.S. Cl. CPC G06Q 30/0244; G06Q 30/0276; G06Q 30/0261

(57) ABSTRACT

A system for presenting branding opportunity information includes a processing device that includes an input module configured to receive a request from a user for branding opportunity information in relation to a temporary space, and a processing module configured to determine one or more branding opportunities in the temporary space. The processing device also includes an output module configured to provide a display of at least part of the temporary space and a visual representation of each branding opportunity of the one or more branding opportunities, the visual representation showing a location and size of the branding opportunity relative to the temporary space.

This application claims the benefit of U.S. Provisional Patent Application Ser. No. 63/349,312 filed Jun. 6, 2022, the disclosure of which is incorporated herein by reference in its entirety.

### BACKGROUND

Hotels, conference centers, and other temporary spaces routinely provide services to clients for hosting meetings, conferences, and various gatherings. Typically, venues focus on the rental of the space with the renter being responsible for adding and providing branding elements within the space. However, it can be difficult for a potential user of the space to accurately visualize different possibilities for branding an event within the space.

### SUMMARY

An embodiment of a system for presenting branding opportunity information includes a processing device that includes an input module configured to receive a request from a user for branding opportunity information in relation to a temporary space, and a processing module configured to determine one or more branding opportunities in the temporary space. The processing device also includes an output module configured to provide a display of at least part of the temporary space and a visual representation of each branding opportunity of the one or more branding opportunities, the visual representation showing a location and size of the branding opportunity relative to the temporary space.

An embodiment of a method of presenting branding opportunity information includes receiving a request from a user for branding opportunity information in relation to a temporary space, determining one or more branding opportunities in the temporary space, and providing a display of at least part of the temporary space and a visual representation of each branding opportunity of the one or more branding opportunities. The visual representation shows a location and size of the branding opportunity relative to the temporary space.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a technology platform configured to perform aspects of embodiments of the present invention;

FIG. 2 depicts an example of a visual representation of available branding opportunities in a venue, as presented to a user;

FIG. 3 depicts an example of a visual representation of available branding opportunities in a region of the venue of FIG. 2, in the form of a line drawing; and

FIG. 4 depicts an example of a photographic representation of the region of FIG. 3, including a rendered branding display simulation;

FIG. 5 depicts an administrator screen as presented by an embodiment of a branding application;

FIG. 6 depicts a venue management screen as presented by the application of FIG. 5;

FIG. 7 depicts a branding location and format management screen as presented by the application of FIG. 5;

FIG. 8 depicts a user management screen as presented by the application of FIG. 5;

FIG. 9 depicts examples of screens displayed to a user by the application of FIG. 5, and illustrates aspects and areas of user interactions with the application; and

FIG. 10 depicts examples of screens displayed to a user by the application of FIG. 5, and illustrates aspects of user interactions with the application;

FIG. 11 depicts an example of an informational package provided to an entity;

FIG. 12 depicts an example of a visual representation provided to an entity based on user selection(s), for example, as part of an informational package; and

FIG. 13 is a block diagram depicting aspects of a method of presenting branding opportunity information;

FIG. 14 is a block diagram illustrating aspects of a method of presenting and selecting branding opportunities, in relation to front end components of a branding application; and

FIG. 15 is a block diagram illustrating aspects of a method of presenting and selecting branding opportunities, in relation to back end components of the branding application of FIG. 14.

### DETAILED DESCRIPTION

Systems, devices and methods are provided herein for presenting branding opportunities in various locations and spaces. An embodiment of a platform includes an application or computer program that provides branding information to a user, such as a client interested in reserving a venue or temporary space for an event. A “temporary space” refers to a location or space intended for temporary use. Examples of such spaces include, but are not limited to, hotels and commercial spaces, etc. A “venue” may refer to a temporary space in its entirety, or a portion thereof (e.g., a floor or conference space).

The branding information may be presented to a user via a suitable interface, such as a touchscreen of a smart phone, tablet, or computer and includes visual representations of available branding opportunities. The visual representations allow the user to visualize the locations, sizes, specifications, and configurations of branding elements as they would appear in the temporary space. For example, the platform can present visual renderings of branding opportunities in response to a user selection or interaction with the interface, and/or based on user location as the user surveys a temporary space. Other types of information may be presented in conjunction with the visual representations, such as pricing information and display options (e.g., options for different sizes and display forms).

The platform includes additional functionality to facilitate aspects of branding selection and reservation of a venue or space. For example, the platform is configured to permit registration of venue owners (“owner” connotates any person or entity that has responsibility for managing a venue or space and/or providing branding displays), and permit inputs regarding available branding opportunities in conjunction with venues that are offered for reservation. In addition, the system is configured to permit registration of users, i.e., persons or entities interested in reserving a venue or space. The platform may also include security features to ensure that only approved venue owners and users have access to the platform.

The platform may present branding opportunities to a user in a variety of contexts. For example, a user can navigate the various pages or screens presented by the system by interacting therewith (e.g., via a mouse or touchscreen). In another example, the system can automatically present visual representations of specific venues, venue regions and branding opportunities based on a user location (e.g., during a walkthrough of the venue).

A “branding opportunity” refers to a location in a temporary space at which a branding element can be applied. A “branding element” refers to any physical or virtual element that presents information to attendees of an event. Such information may include trademarks, logos, product information, event descriptions, marketing information and any other information desired to be temporarily displayed during an event. Element types include, for example, graphic structures, applied graphics, registration desks, backdrops, kiosks, and others. A branding element can be presented visually according to various levels of specificity. For example, a representation of a branding element can be an indication of location in a venue, or can include properties such as size and shape in relation to a venue or space. The representation may include renderings of how the element may appear when installed (e.g., via a photographic simulation or three dimensional rendering).

The system includes a processing device that stores aspects of an application, software programs, modules or any other processing unit or units. In an embodiment, the system stores aspects of an application, such as a mobile application or mobile “app,” that is configured to perform functions related to presentation of branding opportunities.

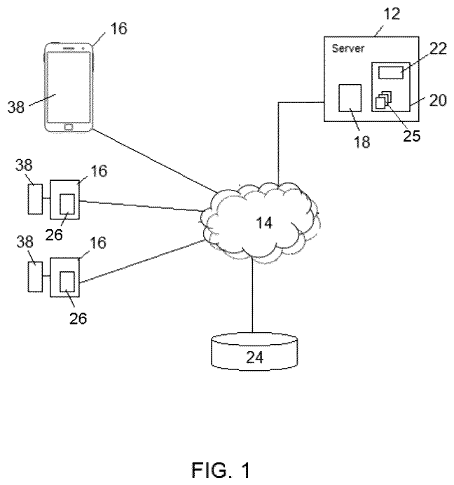

FIG. 1 depicts an embodiment of a system 10 for performing various functions described herein, including presenting branding opportunities. The system 10 provides a technology platform and includes a processing unit or system such as a server 12. The server 12 is connected via a network 14 to one or a plurality of devices 16. The devices 16 may be any computing devices, such as desktop computers, laptop computers, on-board vehicle processors, and mobile devices. For example, the devices 16 include mobile devices such as smartphones or tablets. The server 12 may be a system or device at a given location, or include multiple distributed devices.

The network 14 can be any network that connects a variety of devices, including, but not limited to, local area networks (LANs), wireless networks, wide-area networks (WAN), blockchain networks, the Internet (a network of heterogeneous networks using the Internet Protocol, IP), and virtual private networks.

In an embodiment, each device 16 is registered as a client, and the server 12 is configured as a host. A “server” or “host” may refer to a process or processes that provide a service, and/or the host computer device that performs the process or processes. Likewise, a “client” may refer to a process or processes of communication with the host, and/or the computer device that performs such process or processes. A client may be an entity that owns or manages a temporary space, and/or a user seeking to reserve the space.

The server 12 includes a processor 18 and memory 20 that stores various applications, software programs, processing modules and/or other processing units configured to perform functions related to interacting with the devices 16, acquiring user and owner information, managing users and venue information, presenting branding opportunities and other information, scheduling the use of spaces, verification and others. The memory 20 may store all or part of an application 22 (e.g., a mobile app). For example, the memory 20 stores at least back end components 25 of the application. The memory 20 may also store front end components 26, or front end components may be stored at another location. For example, front end components 26 may be stored in the memory 20, or stored in a separate database or storage location.

Front end components 26 typically include components of the application 22 that are visible to a user and/or that a user interacts with. Front end components may include one or more user interfaces, and one or more processing modules or units configured to store and transmit information input by the user or owner, and receive communications from the server 12. Back end components are typically hidden from the user, and include programs and/or processing units that perform functions including maintaining user information and venue information.

The system 10 includes additional components connected to the network 14. In an embodiment, the system 10 includes one or more databases or other storage devices for storing data used by the application 22. For example, a database 24 may be used to store user and owner information, including user and owner identification information, contact information, venue information, verification data and others. It is noted that the system 10 may store information in various locations, and is not limited to the storage locations shown in FIG. 1.

Each device 16 is configured to install parts of the application 22, particularly front end components of the application 22. For example, each device 16 includes a processing device and storage for storing front end components of the application 22. Each device 16 includes a display 28, such as a touchscreen, that displays an interface, such as a GUI and/or page. The interface allows a user or owner to input information, browse available spaces, select and schedule the use of spaces and branding elements, provide billing information and/or perform other functions.

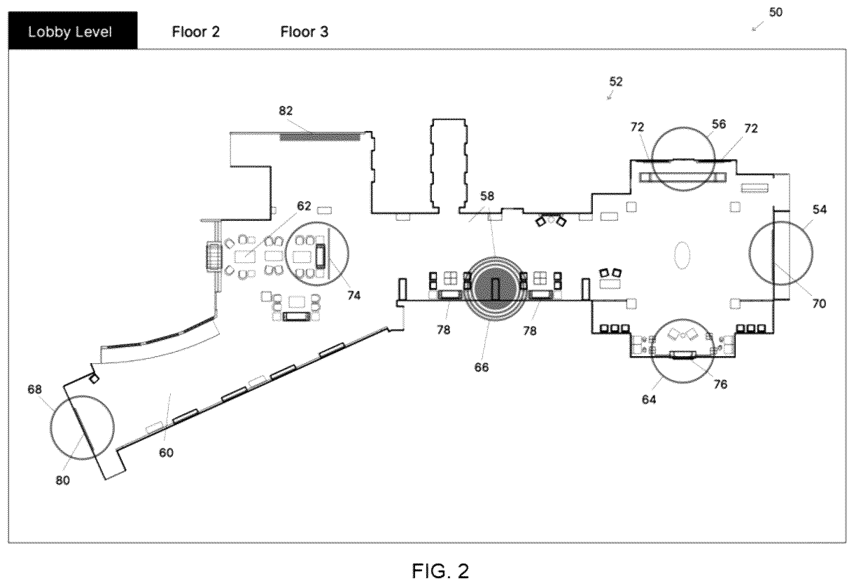

FIG. 2 depicts an example of branding opportunity information that can be presented to a user. The user can use the application as a tool to present to the hotel user's event client, for example. The user can be, for example, the venue owner or other authorized user or presenter. As shown, the user can navigate between different venues within the hotel using tabs labeled “Lobby Level”, “Floor 2” and “Floor 3”.

When the user selects the Lobby Level tab, a floor plan display 50 is provided, which schematically shows the layout of a lobby level 52 of the hotel. The display 50 functions as an interactive map that the user can interact with to receive more detailed branding opportunity information in specific regions of the lobby. Selection of a specific region or location in the floor plan display causes the application to present a visual representation of the location or region and show available branding opportunities. For example, selection of a region prompts presentation of a line drawing, photographic display, video, animation, three dimensional rendering and/or any other suitable type of representation.

The lobby level 52 includes a front entrance 54, a registration counter area 56, walkways 58 and 60, seating areas 62, 64 and 66, and a doorway 68. One or more of these regions can be bounded by a circle or highlighted in some other way to indicate to the user that a respective region can be selected for more detailed information.

The floor plan display 50 also provides information regarding available branding locations at which branding elements may be added. The branding locations may be represented by branding indicators that indicate the location (and potentially other parameters such as size or length) of each branding location. Each branding indicator may represent one or more specific branding elements.

In the example of FIG. 2, the floor plan display includes a branding indicator 70 at the front entrance 54, branding indicators 72 at the counter area 56, and branding indicators 74, 76 and 78 at the seating areas. Other indicators include a branding indicator 80 at the doorway 68 and a branding indicator 82.

In this example, the user can select (e.g., via mouse or touchscreen) specific sections of the lobby level for more detailed branding information. The user can select specific branding elements or select a circled region. For example, if the user selects the front entrance 54 (e.g., by selecting the circle or clicking or touching the region therein), the application provides a local display that provides one or more views of the front entrance and a representation of approved locations, sizes, shapes and/or other parameters.

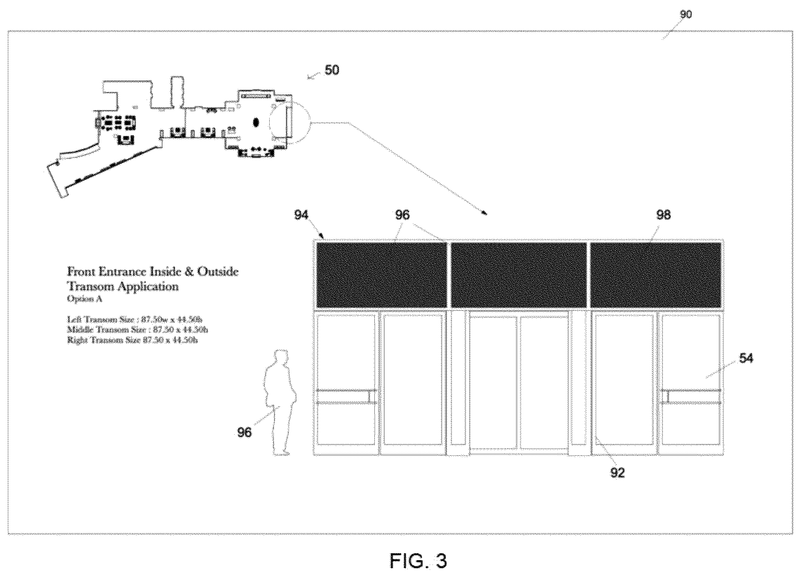

FIG. 3 is an example of a specific display 90, which includes a line drawing of the front entrance. The line drawing shows an entryway 92 and a transom 94 located above the entryway. A drawing of a person 96 is shown to give the user a sense of scale. The display 90 may also include size or dimensions of components of the front entrance and available branding opportunities. In this example, the display 90 shows three branding regions 98 on which branding elements may be located.

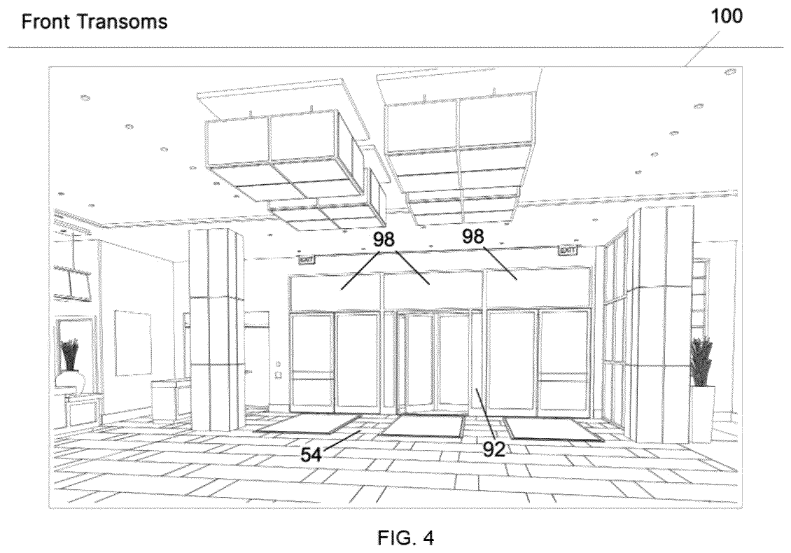

FIG. 4 depicts another example of a visual representation that can be presented. This example includes a photographic representation/rendering or rendered image 100 of the front entrance 54, which shows a rendering of a branding element on the branding regions 98 above the entryway 92. Other display modalities may include graphic structures, panoramic type displays, three dimensional representations and others.

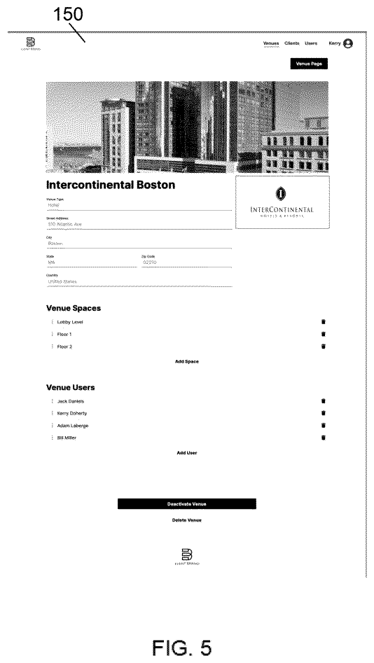

FIGS. 5-10 depict examples of screens or GUIs presented to a user or owner as the user or owner navigates through the application. In these examples, the application is a mobile application, website, PC program or any other suitable computer program or programs. Also in these examples, the temporary space is a hotel that offers multiple venues for reservation by a user; however, embodiments described herein are not so limited.

FIG. 5 depicts an example of an administrator screen 150 that can be accessed, for example, by an owner of a temporary space. In this example, the administrator screen is a “venue page” that presents information relating to a hotel, and information describing venues in the hotel. The owner, after being registered, is able to manage the venues (e.g., add or remove venues) as well as scheduled or prospective users of the venues.

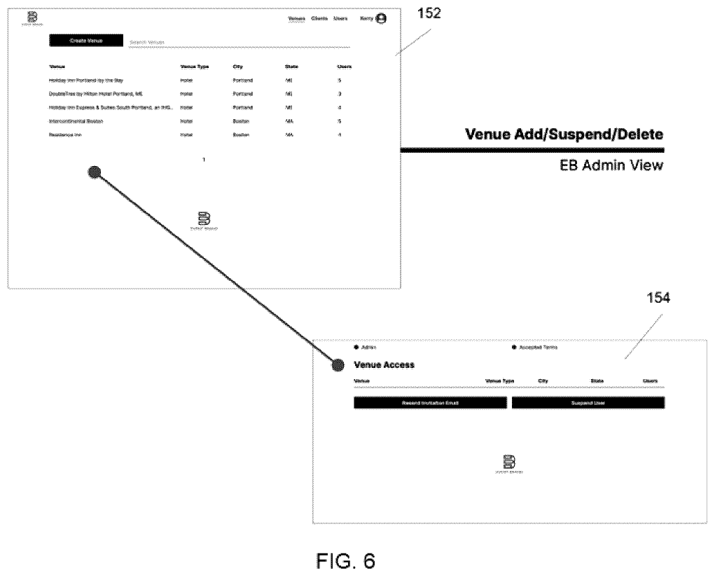

FIG. 6 depicts an example of a venue management screen 152 that can be accessed by the owner. The venue management screen 152 allows the owner to create venue listings, add venue listings and remove venue listings. The venue management screen 152 is linked to a venue access screen 154 that allows the owner to manage a user's access to a venue or venue information. For example, the owner can permit access so that the user can access branding opportunity information related to the venue, or suspend user access.

In addition, the venue management screen (or other aspect of the application) can be used to send venue and branding opportunity information to a user. For example, when a user has selected a venue and selected from available branding opportunities, the application can email or otherwise transmit a package including images and representations based on the user selections.

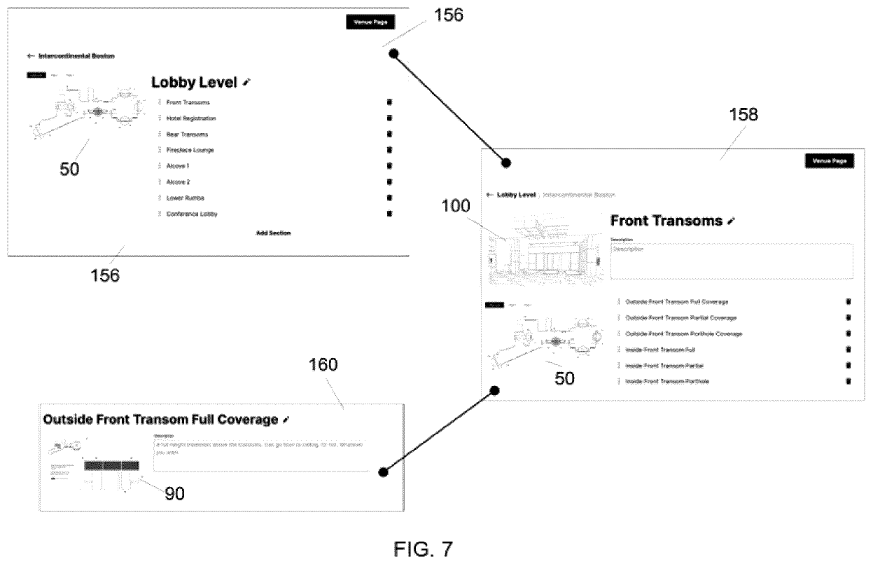

FIG. 7 depicts branding management screens, which allow the owner to manage the available branding opportunities and visual representations thereof. In this example, the owner selects the floor plan display 50, and the application displays a list of regions of the lobby level in a management screen 156. Details related to these regions can be added or removed. In addition, representations of branding opportunities (e.g., branding indicators) can be added, modified or removed as desired.

For example, the user can select the front entrance region 54 (listed as “Front Transoms”) from the management screen 156, and select from a list of branding configurations from a management screen 158. As shown, the branding configurations include full coverage, partial coverage and others. The selected coverage is then presented in another management screen 160 as various visual representations that can be presented to a user. In the example of FIG. 7, the owner is able to select from a line drawing (e.g., the line drawing display 90) and one or more photographic images.

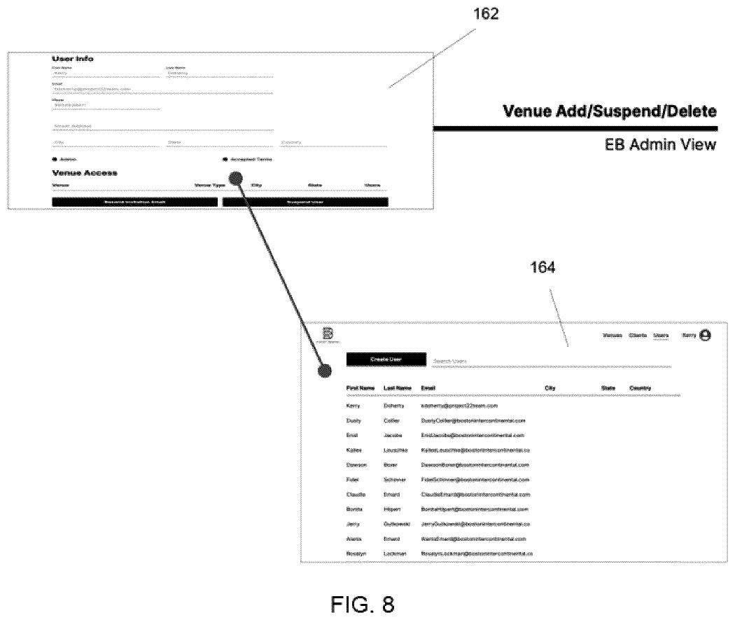

FIG. 8 depicts a user management screen. At these screens, the owner can manage access to a venue by various users. In addition, user information can be entered and accessed. For example, a user management screen 162 allows an owner or other authorized user to input information for a specific user (e.g., for adding a new user or updating an existing user), and a user management screen 164 allows an authorized user to maintain listings of users.

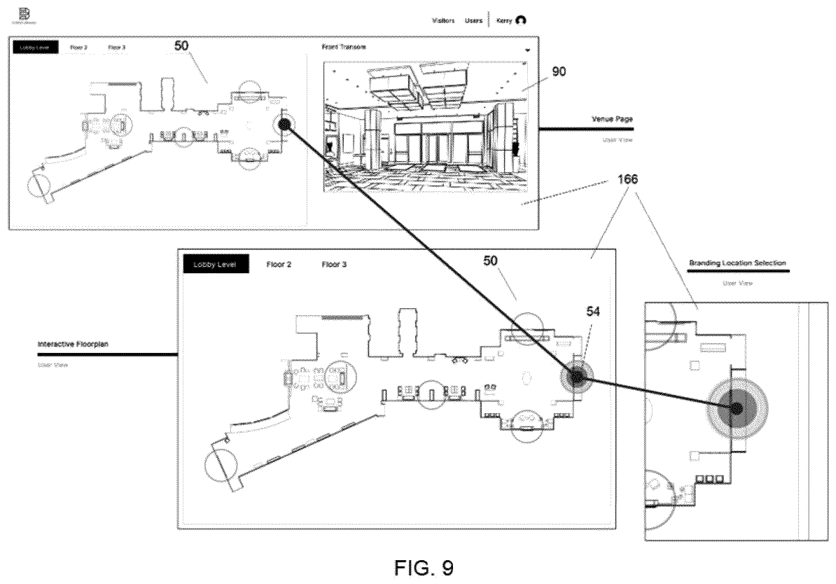

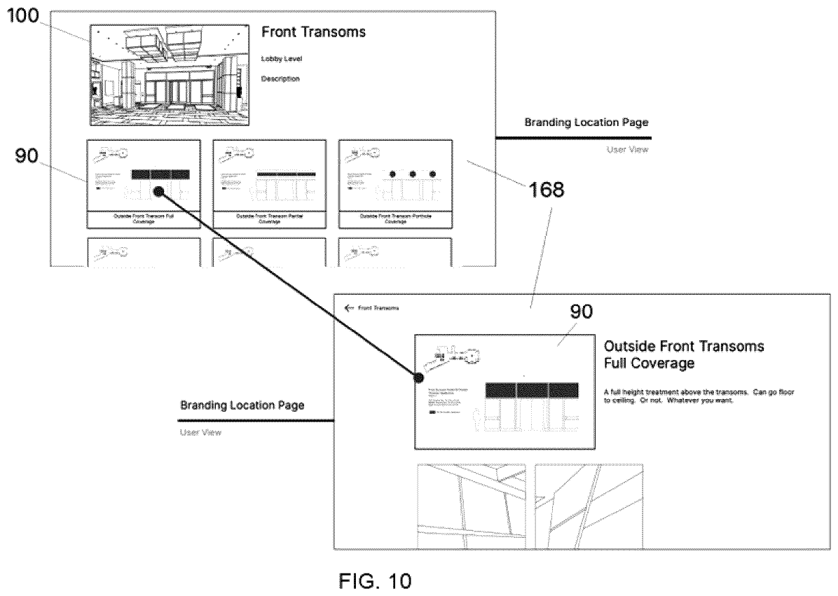

FIGS. 9 and 10 depicts an example of information presented to a user as the user navigates through the application. In this example, the user has been registered and permitted access to information about a lobby level of the hotel via user venue page 166. As shown, the user can survey the floor plan display 50 and select various regions or locations, which will prompt the presentation of additional information, including available branding display configurations, pricing information, availability for reservation and others.

In this example, the user selects the front entrance region 54 from the user venue page 166 (FIG. 9), which prompts the presentation of visual representations of available branding configurations in a branding location page 168. One such configuration is shown via the line drawing display 90, which represents full transom coverage. The user can select the display 90, which prompts the presentation of an expanded view of the display 90, along with the photographic image 100. Additional information can also be presented here, such as pricing, types of branding displays and others.

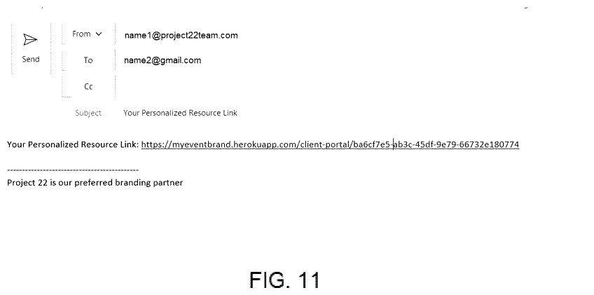

When the user completes selections, the application may automatically transmit an informational package to the user and/or other requested or authorized entity. The package may be in any suitable form, such as an email or text message including an attachment or link to a website or page. For example, as shown in FIG. 11, the package can be transmitted to the user (or other authorized entity) in the form of an email including a personalized resource link.

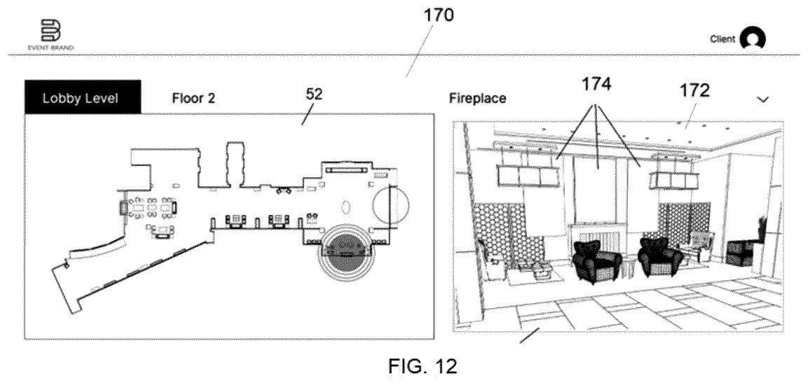

FIG. 12 shows an example the contents of an informational package. In this example, the contents are in the form of a web page 170 provided via hyperlink (e.g., the link of FIG. 11). As shown, the web page displays a map or floor plan of a venue selected by a user (e.g., the floor plan 52), as well as a realistic drawing or photographic display 172 of what the space might look like with a branding element installed. In this example, the photographic display 172 shows a brand image 174 disposed on screens or other suitable surfaces.

Embodiments described herein thus allow event clients to actually see their selected branding opportunity locations, and can see what the space will look like with branding. The event client can share this information with their events team and not have to rely on memories or imaginations; images are right there for review.

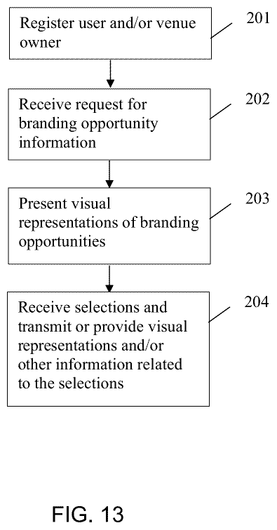

FIG. 13 illustrates an embodiment of a method 200 of presenting branding opportunities. Aspects of the method 200 may be performed by a processor or processors, such as the server 12. It is noted the method 200 may be performed by any suitable processing device or system, or combination of processing devices, or any suitable technology platform.

The method 200 includes a number of steps or stages represented by blocks 201-204. The method 200 is not limited to the number or order of steps therein, as some steps represented by blocks 201-204 may be performed in a different order than that described below, or fewer than all of the steps may be performed.

Aspects of the method 200 are discussed in conjunction with the system 10 shown in FIG. 1, for illustration purposes. The method 200 is not so limited and can be used with any suitable system or platform.

At block 201, a user, owner and/or other entity registers with the system 10. For example, an owner of a hotel or other space registers with the system 10 and provides relevant identification and venue information. A user (e.g., an event organizer) also registers and provides relevant identification information, and may also provide information regarding preferences as to properties of spaces (e.g., location, size, amenities, etc.).

At block 202, a user interacts with the system 10 and submits a request for venue information and/or branding opportunity information (e.g., by selecting or clicking on a value listing). In response, at block 203, the system 10 presents branding information including visual representations and other information as discussed above. For example, a user can access a website or other platform, and interact with various pages or screens as discussed above to explore available opportunities.

At block 204, the system 10 receives selections from the user regarding one or more desired venues and/or options for branding opportunities in one or more desired venues. For example, if a user selects a specific venue or venues, the system 10 transmits an informational package include visual representations of the selected venue(s) and various options for locations, sizes shapes and other configurations of available branding elements. If a user selects specific locations and/or specific branding element configurations, the informational package is customized to present options based on the selections.

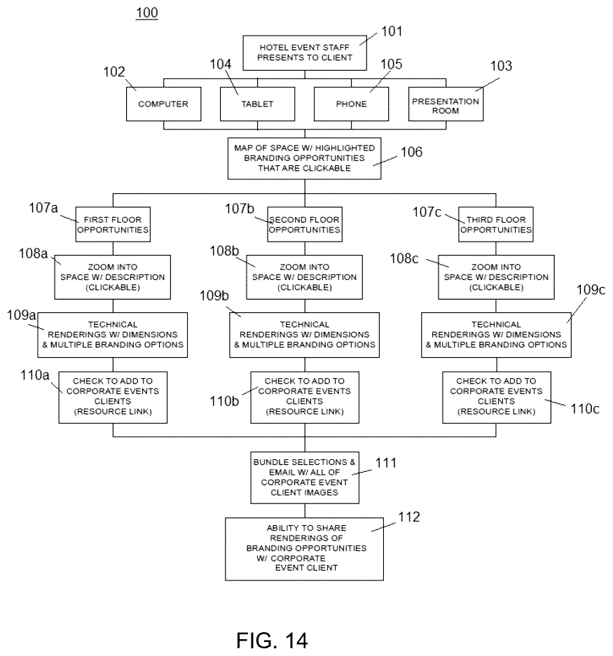

FIG. 14 is a flow diagram illustrating an example of a method 100 of presentation and selection of branding opportunities, in relation to front end components 26 of the application 22.

At block 101, a user presents branding opportunities by opening (or directing clients to open) the application 22 and/or navigating to a presentation that provides information regarding available hotel venues. In this example, the available venues include a first floor venue (e.g., a lobby level), a second floor venue (e.g., one or more convention spaces) and a third floor venue (e.g., one or more conference rooms, hotel rooms, suites, etc.).

Branding opportunities can be presented to clients in person and/or remotely. For example, application screens or pages can be presented via a computer (block 102) and/or a display screen in a presentation room or other location (block 103). Alternatively, the screens or pages can be presented on a mobile device or devices, such as a tablet or tablets (block 104) and/or a smartphone or smartphones (block 105).

If mobile devices are used, branding opportunities can be presented as clients move through the hotel, allowing for a walkthrough if desired. In some aspects, location tracking can be employed to automatically present maps and renderings based on location.

The presentation may include a map of one or more available venues (block 106). The map is interactive, allowing for the selection of individual venues and/or individual locations within a venue.

For example, at block 107a, first floor opportunities are presented by displaying a map or other representation of available spaces in the first floor of the hotel, such as the floor plan display 50. A location or region in the floor plan display 50 is clicked or otherwise selected (block 108a), prompting a zoom in view or other more detailed representation of the selected location or region. At block 109a, one or more renderings that describe technical specifications (e.g., size, dimensions, location, available types of branding elements) are presented in response to the selection. An example of such renderings is the display 90 of FIG. 3.

At block 110a, selected first floor opportunities (e.g., all or part of the display 90) are added to a document or file, or connected to a hyperlink, which is provided to the clients to allow the clients to revisit the opportunities.

Presentation of opportunities and selection of locations and regions of venues is repeated for each additional venue. For example, second floor opportunities are presented, selected and added as shown in blocks 107b-110b. Third floor opportunities are presented, selected and added as shown in blocks 107c-110c.

At block 111, all of the selections from blocks 110a, 110b and 110c are bundled into an informational package that is provided to the clients. The informational package can be provided as an attachment or hyperlink in an email, text message or other communication (block 112) to the clients and/or other interested and authorized parties.

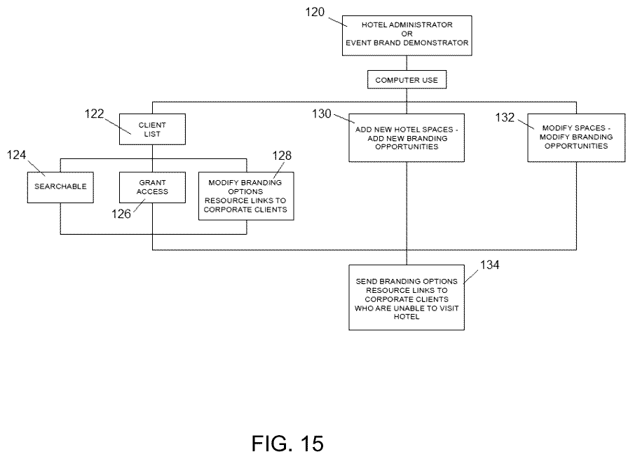

FIG. 15 is a block diagram illustrating examples of functions of back end components 25 of the application 22. The backend components 25 are accessible by an authorized user 120, such as a hotel administrator, venue owner, authorized presenter or other user granted administrator access. The backend components allow the user 120 to maintain and/or view a client list 122. The user 120 can perform functions such as adding and removing clients, performing a search (block 124), granting access (block 126), and adding, removing or otherwise modifying branding opportunities linked to a specific client in the list (block 128).

In addition, the user 120 can manage a list or collection of spaces maintained by the application 22. For example, the user can add new spaces (e.g., hotels), venues and/or new branding opportunities (block 130). In addition, the user can modify existing spaces, venues and/or branding opportunities (block 132). Further, at block 134, selections of branding opportunities and/or informational packages can be sent to various remote entities (e.g., clients unable to visit a space for a presentation).

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments of the invention, the practical application or technical improvement over technologies found in the marketplace, or to enable others of ordinary skill in the art to understand the embodiments described herein.

What is claimed is:

1. A system for presenting branding opportunity information, the system comprising:
a processing device including:
an input module configured to receive a request from a user for branding opportunity information in relation to a temporary space;
a processing module configured to determine one or more branding opportunities in the temporary space; and
an output module configured to provide a display of at least part of the temporary space and a visual representation of each branding opportunity of the one or more branding opportunities, the visual representation showing a location and size of the branding opportunity relative to the temporary space.

2. The system of claim 1, wherein the display includes an interactive floor plan of at least part of the temporary space.

3. The system of claim 2, wherein the interactive floor plan includes one or more selectable regions, each selectable region including at least one branding opportunity.

4. The system of claim 3, wherein the output module is configured to present a detailed representation of a selected region, the detailed representation showing a location of each available branding opportunity.

5. The system of claim 4, wherein the detailed representation includes a plurality of individual representations, each individual representation showing a different configuration of each available branding opportunity.

6. The system of claim 1, wherein the display is provided by an application operating on a selected platform, the application including front end components accessible by a user, wherein the front end components are configured to present available temporary spaces to the user and permit the user to interact with representations of temporary spaces, receive user selections, present available temporary spaces based on the user selections, and present pricing information.

7. The system of claim 1, wherein the display is provided by an application operating on a selected platform, the application including backend components accessible by an authorized user to manage temporary spaces and user information, the user information including user identifications and temporary spaces reserved by one or more users.

8. The system of claim 1, wherein the processing device is configured to automatically transmit an informational package to the user, the informational package providing information regarding each branding opportunity selected by the user.

9. The system of claim 1, wherein the processing device is configured to automatically present the display of at least part of the temporary space or a region of the temporary space based on a location of the user.

10. The system of claim 1, wherein the visual representation includes at least one of a floor plan, a line drawing, a rendered image and a photographic representation of the one or more branding opportunities and a region including the one or more branding opportunities.

11. A method of presenting branding opportunity information, the method comprising:
receiving a request from a user for branding opportunity information in relation to a temporary space;
determining one or more branding opportunities in the temporary space; and
providing a display of at least part of the temporary space and a visual representation of each branding opportunity of the one or more branding opportunities, the visual representation showing a location and size of the branding opportunity relative to the display.

12. The method of claim 11, wherein the display includes an interactive floor plan of at least part of the temporary space.

13. The method of claim 12, wherein the interactive floor plan includes one or more selectable regions, each selectable region including at least one branding opportunity.

14. The method of claim 13, further comprising presenting a detailed representation of a selected region, the detailed representation showing a location of each available branding opportunity.

15. The method of claim 14, wherein the detailed representation includes a plurality of individual representations, each individual representation showing a different configuration of each available branding opportunity.

16. The method of claim 11, wherein the display is provided by an application operating on a selected platform, the application including front end components accessible by a user, wherein the front end components are configured to present available temporary spaces to the user and permit the user to interact with representations of temporary spaces, receive user selections, present available temporary spaces based on the user selections, and present pricing information.

17. The method of claim 11, wherein the display is provided by an application operating on a selected platform, the application including backend components accessible by an authorized user to manage temporary spaces and user information, the user information including user identifications and temporary spaces reserved by one or more users.

18. The method of claim 11, further comprising automatically transmitting an informational package to the user, the informational package providing information regarding each branding opportunity selected by the user.

19. The method of claim 11, wherein the display of at least part of the temporary space or a region of the temporary space is automatically presented to the user based on a location of the user.

20. The method of claim 11, wherein the visual representation includes at least one of a floor plan, a line drawing, a rendered image and a photographic representation of the one or more branding opportunities and a region including the one or more branding opportunities.
